(19) United States
(12) Patent Application Publication
(10) Pub. No.: US 2002/0128990 A1
(43) Pub. Date: Sep. 12, 2002

(54) Control methodology and apparatus for reducing delamination in a book binding system

(76) Inventors: Paul A. Kaminskas, Hinsdale, IL (US); Hans Joachim Viebach, New Lenox, IL (US); Did-Bun Wong, Glen Ellyn, IL (US); Larry E. Pettit, Crawfordsville, IN (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/000,710

(22) Filed: Oct. 31, 2001

Related U.S. Application Data
(63) Continuation-in-part of application No. 09/354,261, filed on Jul. 15, 1999.
Application No. 09/354,261 is a continuation-in-part of application No. 08/847,114, filed on May 1, 1997, now Pat. No. 6,009,421.

(51) Int. Cl. G06F 17/00

(52) U.S. Cl. 706/45

(57) ABSTRACT

A device that determines conditions under which a book cover and page delamination is more likely to occur in a binder subassembly line of a book binding system collects and stores data pertaining to numerous bindery process variables such as, temperatures of a glue pot assembly, temperatures of a gas burner assembly, ambient temperatures and humidity of the air surrounding the binder subassembly line, viscosity values for an emulsion glue, and moisture content measurements of the emulsion glue after application of the emulsion glue to a backbone of a book. The device then implements a correlation analysis using the stored data to determine if there is a correlation between data and the occurrence of a delamination, and produces an optimal value or range for operation of the book binding system.

### RELATED APPLICATION

This is a continuation-in-part of U.S. patent application Ser. No. 09/354,261 filed Jul. 15, 1999, which is a continuation-in-part of U.S. patent application Ser. No. 08/847,114, filed May 1, 1997, which issued as U.S. Pat. No. 6,009,421 on Dec. 28, 1999.

### TECHNICAL FIELD

The present invention relates generally to book binding systems and more particularly to a control methodology and device that identifies conditions leading to, and that decreases the occurrence of, book cover and/or book signature delamination within a book binding system.

### BACKGROUND ART

Book binding systems are generally configured in an assembly line fashion and typically include a collating subassembly line for gathering and collating the pages of text in the proper order, a binder subassembly line for binding, or glueing, the sheets of text together and to the cover, and a trimming subassembly line for trimming the book to the desired size and shape.

A common and recurring problem in book binding systems is the occurrence of book cover and/or book signature delamination. Book cover delamination happens when the book cover does not properly adhere to the book backbone during or after it passes through the binder subassembly line. Similarly, book signature delamination happens when the “signatures,” or booklet sections which make-up the book, do not adhere to the book backbone during or after it passes through the binder subassembly line. Furthermore, in some instances, the glue bath does not adhere to a portion of the individual page edges of the backbone. As a result, those individual pages are not affixed in the book, and the book is ultimately rejected.

While book cover and signature delamination is a common problem in the printing industry, the reasons or conditions that lead to the occurrence of book cover and signature delamination vary widely. In fact, book cover and signature delamination may be caused by different factors or by different combinations of factors at different times in the same book binding system. Generally, book cover and signature delamination is avoided by having a local expert, such as a bindery operator, oversee book binding system conditions and make suggestions for changes based mainly on past experiences with book cover and signature delamination, trial and error and general rules of thumb. While some of these approaches are successful in decreasing the incidence of book cover and signature delamination in the short term, book cover and signature delamination problems usually reappear later with very little indication as to the real cause of the reappearance. Furthermore, while local bindery operators are usually capable of determining the general cause of any particular book cover and signature delamination after the delamination has occurred and, moreover, are generally capable of altering book binding system conditions to eliminate a particular cause of a delamination in the short term, there is no guarantee that the altered conditions will not result in further book cover and signature delaminations for other reasons or that the book binding system conditions suggested by the local bindery operator will be implemented in the book binding systems for a long period of time.

It has been suggested to use an expert system to determine the causes of problems, such as ink banding and web breaks, within a printing system. In particular, U.S. Pat. No. 5,694,524 which issued on Dec. 2, 1997, is directed to the use of a decision-tree induction analysis that identifies conditions leading to a particular result, such as ink banding, within a printing system. The use of such a decision-tree induction analysis may also be applied to identify conditions leading to book cover and signature delamination within book binding systems.

In general, expert systems are used to mimic the tasks of an expert within a particular field of knowledge or domain, or to generate a set of rules applicable within the domain. In these applications, expert systems must operate on objects associated with the domain, which may be physical entities, processes or even abstract ideas. Objects are defined by a set of attributes or features, the values of which uniquely characterize the object. Object attributes may be discrete or continuous.

Typically, each object within a domain also belongs to or is associated with one of a number of mutually exclusive classes having particular importance within the context of the domain. Expert systems that classify objects from the values of the attributes for those objects must either develop or be provided with a set of classification rules that guide the system in the classification task. Some expert systems use classification rules that are directly ascertained from a domain expert. These systems require a “knowledge engineer” to interact directly with a domain expert in an attempt to extract rules used by the expert in the performance of his or her classification task.

Such a system is disclosed in U.S. Pat. No. 5,694,524. This method has the advantage of using the expert in a way that the expert is accustomed to working, that is, identifying whether particular rules are relevant or useful in the classification task. It should be noted, however, that all of the relevant attributes of the objects being classified must be identified and data for those attributes must be provided within the records in order for the system to induce accurate and complete classification rules.

It is also known to use artificial intelligence within expert systems for the purpose of generating classification rules applicable to a domain. For example, an article by Bruce W. Porter et al., Concept Learning and Heuristic Classification in Weak-Theory Domains, 45 Artificial Intelligence 229-263 (1990), describes an exemplar-based expert system for use in medical diagnosis that removes the knowledge engineer from the rule extraction process and, in effect, interviews the expert directly to determine relevant classification rules.

In this system, training examples (data sets that include values for each of a plurality of attributes generally relevant to medical diagnosis) are presented to the system for classification within one of a predetermined number of classes. The system compares a training example with one or more exemplars stored for each of the classes and uses a set of classification rules developed by the system to determine the class to which the training example most likely belongs. A domain expert, such as a doctor, either verifies the classification choice or instructs the system that the chosen classification is incorrect. In the latter case, the expert or “knowledge engineer” identifies the correct classification choice and the relevant attributes, or values thereof, that distinguish the training example from the class initially chosen by the system. The system builds the classification rules from this information, or, if no rules can be identified, stores the misclassified training example as an exemplar of the correct class. This process is repeated for training examples until the system is capable of correctly classifying a predetermined percentage of new examples using the stored exemplars and the developed classification rules.

Other artificial intelligence methods that have been used in expert systems which rely on machine induction instead of a knowledge engineer. In machine induction, a set of induction rules are developed or are induced directly from a set of records, each of which includes values for a number of attributes of an object and an indication of the class of the object. An expert then reviews the induced rules to identify which rules are most useful or applicable to the classification task being performed.

A classic example of a pure machine induction technique is described in an article by J. R. Quinlan, Induction of Decision Trees, 1 Machine Learning 81-106 (1986). This technique searches through relations between combinations of attribute values and classes of objects to build an induction tree which is then used to generate precise classification rules. During operation, the Quinlan method calculates a statistical measurement, referred to as an information gain value, for each of a set of attributes and chooses the attribute with the highest information gain value at a root of the tree. The attribute values associated with the chosen attribute are then identified as nodes of the tree and are examined. If all of the data records associated with a node are all of the same class, the node is labeled as a leaf or endpoint of the induction tree. Otherwise, the node is labeled as a branching point of the induction tree. The method then chooses a branching point, calculates the information gain value for each of the remaining attributes based on the data from the records associated with the chosen branching point, chooses the attribute with the highest information gain value and identifies the attribute values of the chosen attribute as nodes which are examined for leaves and branching points. This process may be repeated until only leaves remain within the induction tree or until, at any existing branching point, there are no attributes remaining upon which to branch. After an induction tree is constructed, classification rules are generated therefrom by tracing a path from a particular leaf of the induction tree to the root of the induction tree or vice versa.

As noted above, choosing the appropriate, non-inconsequential variables or attributes for an expert system is an important step in identifying the cause of a problem. Without the appropriate choice of attributes, the expert system can be practically useless in actually determining the causes of problems.

### BRIEF DESCRIPTION OF THE DRAWINGS

FIG. 1 is a high level block diagram of a book binding system;

FIG. 2 is a pictorial illustration of a book as it travels through the binder subassembly line of FIG. 1.;

FIG. 3 illustrates an embodiment of a glue subassembly depicted in FIG. 1;

FIG. 4 is a block diagram of a system for use in building an induction tree;

FIGS. 5A and 5B, when joined along similarly lettered lines, together form a flowchart of steps undertaken during a method of identifying conditions leading to book cover and signature delamination;

FIG. 6 is a flowchart of programming executed by the system of FIG. 4 for implementing a portion of the method identified by the flowchart of FIGS. 5A and 5B; and

FIGS. 7A and 7B, when joined along similarly lettered lines, together form a flowchart of programming for implementing a block of FIG. 6.

### DESCRIPTION OF THE PREFERRED EMBODIMENT

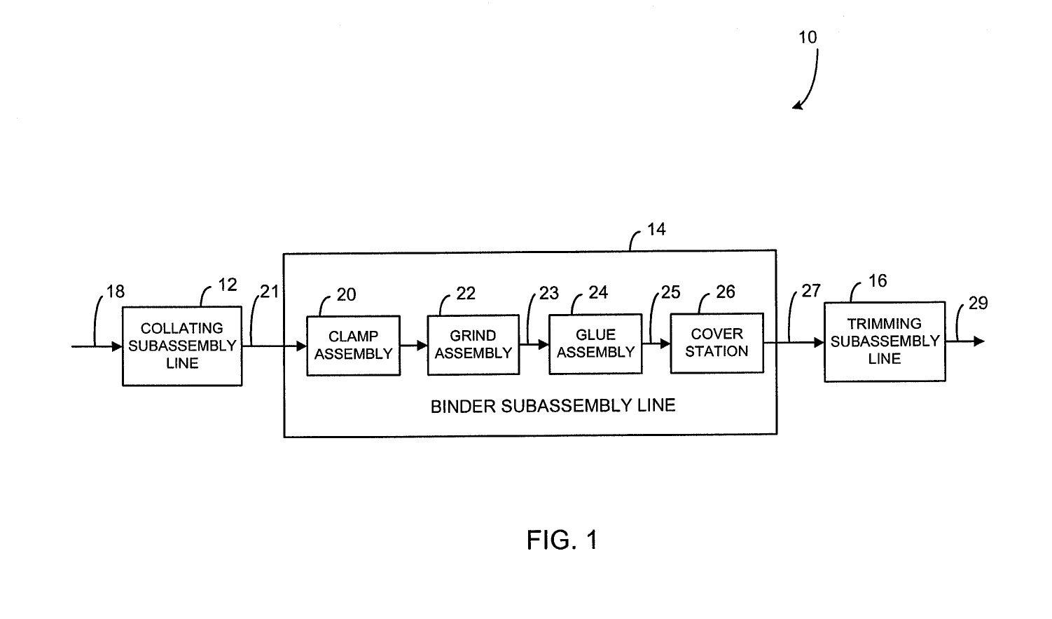

Referring to FIG. 1, book binding systems, such as book binding system 10, are generally configured in an assembly line fashion and include a collating subassembly line 12 for collating sheets of text, or pages, in the proper order, a binder subassembly line 14 for binding, or glueing the pages together with the book cover, and a trimming subassembly line 16 for trimming the book to the desired size and shape. For purposes of discussion, a book binding system for soft-cover books is described herein. Although similar, the book binding system for hardcover books varies slightly from the book binding system for soft-cover books primarily with respect to application of the book cover.

Beginning in the collating subassembly line 12, individual booklet sized sections or signatures 18 are placed into a series of adjacent hoppers. The individual signatures 18 are formed by folding a large sheet of paper containing the text such that the folded edge of the large sheet can be removed to yield a stack of smaller individual pages. The individual signatures 18 are gathered in the collating subassembly line 12 into stacks of signatures in the order in which they will be bound to form the final book. The gathering and collating steps are accomplished through the use of a conveyor belt, or trough, passing under the hoppers. For example, a first signature drops from a first hopper onto the conveyor belt moving underneath the hoppers. The conveyor belt moves the first signature to a point directly below a second hopper which releases a second signature on top of the first signature. The process continues until a stack is formed at the output of the collating subassembly line 12. Next, the stack, generally referred to as a book block 21, enters the binder subassembly line 14 where the book block 21 is held firmly together by a clamp assembly 20. The clamp assembly 20 is configured to hold the book block 21 together while allowing the book block 21 to be processed as it travels through the binder subassembly line 14. As the book block 21 passes through the binder subassembly line 14, the backbone of the book block 21, composed of the folded sides of the signatures 18, is subjected to a grinding process in a grind assembly 22. After passing through the grinding process, a grinded book block 23, with its individual backbone page edges exposed, is passed through a book binding glue bath at a glue assembly station 24 to produce a book 25. The binding process is completed when a book cover, carried by a separate conveyor system from a cover station 26, meets and is applied to the book 25 to form a covered book 27. Finally, the covered book 27 enters the trimming subassembly line 16 where it is trimmed to a uniform shape to produce a finished book 29.

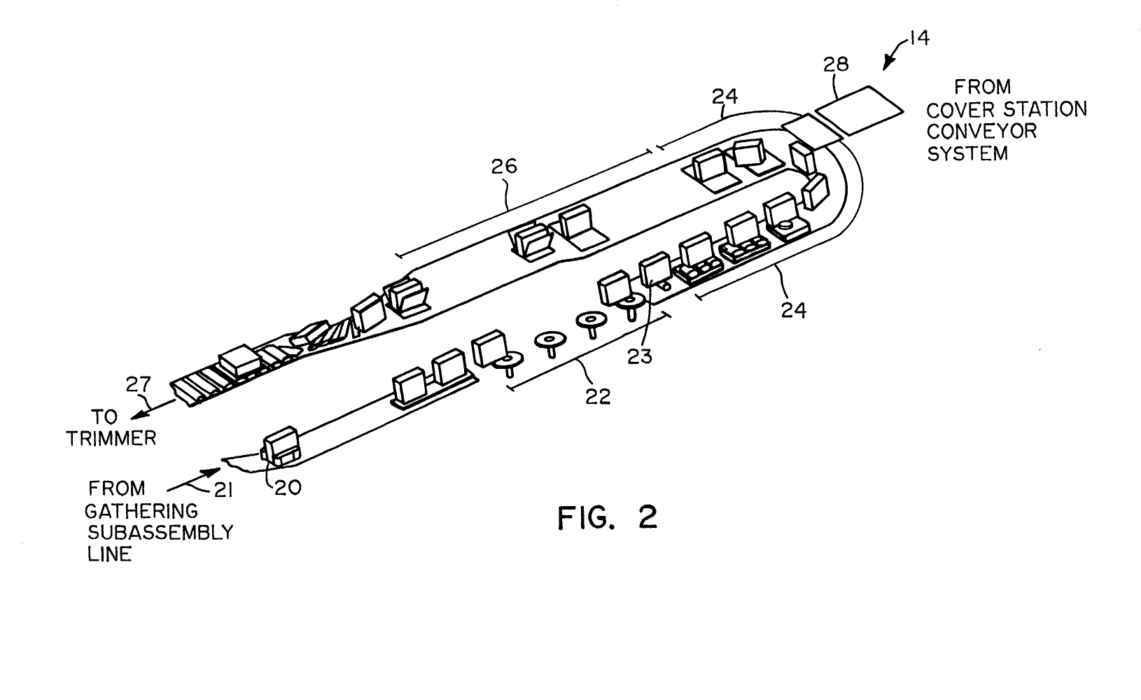

FIG. 2, is a pictorial illustration of a book as it travels through the binder subassembly line 14 of FIG. 1. As shown, each book block 21 is received by the binder subassembly line 14, clamped together by the clamp assembly 20, and is subjected to grinding by the grind assembly 22. Although only one instance of the clamp assembly 20 is shown in FIG. 2, the clamp assembly 20 continues to clamp the book block 20 as it travels through the binder subassembly line 14. The page edges subjected to the grinding process are coated with an emulsion glue followed by a hot melt glue at the glue assembly station 24, and a book cover 28, conveyed from the cover station 26, is affixed to each book 25 to form a covered book 27. Each covered book 27 is forwarded from the binder subassembly line 14 to the trimming assembly line 16 not shown in FIG. 2. The covered book 27 then undergoes final trimming and finishing steps to produce a finished book 29.

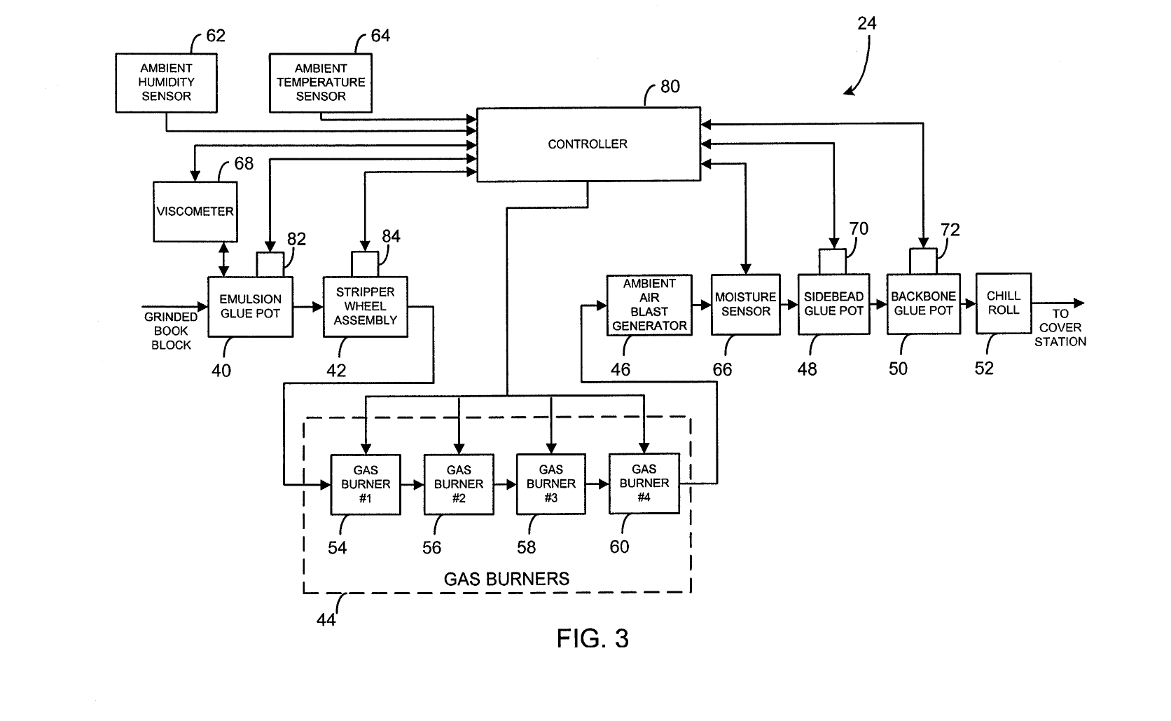

FIG. 3 is a block diagram of an embodiment of the glue assembly station 24 depicted in FIG. 1. The glue assembly station 24 may be configured so that the grinded book block 23 travels in a loop fashion at an adjustable line speed determined by a bindery operator. The glue assembly station 24 includes an emulsion glue pot 40, a stripper wheel assembly 42, a set of gas burners 44, an ambient air blast generator 46, a side bead glue pot 48, a backbone glue pot 50, and a chill roll 52. It should be noted that although the set of gas burners 44 in FIG. 3 includes four gas burners, a gas burner 54, a gas burner 56, a gas burner 58, and a gas burner 60, more or less gas burners may be utilized in the glue assembly station 24. Furthermore, the glue assembly station 24 of FIG. 3 also includes a moisture sensor 66 located between the ambient air blast generator 46 and the side bead glue pot 48. In addition, although not part of the glue assembly station 24, an ambient humidity sensor 62 and an ambient temperature sensor 64 is centrally located at a point along the binder subassembly line 14.

A viscometer 68 for measuring the viscosity of the emulsion glue is coupled to the emulsion glue pot 40. The side bead glue pot 48 is fitted with a first thermocouple 70, and the backbone glue pot 50 is fitted with a second thermocouple 72. Similarly, the gas burners 54, 56, 58, 60 are each fitted with a thermocouple (not shown). The ambient humidity sensor 62, the ambient temperature sensor 64, the viscometer 68, the first thermocouple 70, the second thermocouple 72, the moisture sensor 66, and the thermocouples associated with the set of gas burners 44, are communicatively coupled to a controller 80. In addition, an emulsion glue wheel scraper indicating device 82 and a stripper wheel scraper indicating device 84 are coupled to the emulsion glue pot 40 and the stripper wheel assembly 42, respectively, and are communicatively coupled to the controller 80. The scraper measuring devices 82 and 84 may be any devices capable of enabling manual, mechanical, or electronic distance indication between the series of wheel scrapers and their corresponding series of wheels used in the emulsion glue pot 40 and the stripper wheel assembly 42. The controller 80 may be any standard bindery controller including, for example, any analog, digital, hardwired processor or microprocessor typically found in a personal computer (PC) having input/output capability. The controller 80 preferably includes a central processing unit electrically coupled to a memory device and an interface circuit.

Generally, during operation of the glue assembly station 24, the individual backbone page edges exposed by the grinding process are subjected to a two-step process. First a primer glue, herein referred to as an emulsion glue, is applied to the backbone. Second, a binding glue, herein referred to as a hot melt, is applied to the backbone. Between the first and second steps, various temperature and humidity controls are implemented to maximize subsequent adhesion of the book cover and the book pages to the backbone.

Specifically, during operation of the glue assembly station 24, the grinded book block 23, having been clamped at the clamp assembly 20 and having been subjected to grinding by the grind assembly 22, is carried through the emulsion glue pot 40. An emulsion glue, for example the emulsion glue manufactured by HB Fuller, is applied to the backbone page edges as they pass through the emulsion glue pot 40. The emulsion glue acts as a “primer” by soaking into the paper in the backbone area of the grinded book block 23 in preparation for subsequent hot melt and book cover application. The emulsion glue pot 40 includes a series of adjustable emulsion glue wheels with corresponding emulsion glue wheel scrapers (not shown). The adjustable emulsion glue wheels, partially submerged in the emulsion glue, rotate through the emulsion glue, in the direction of backbone travel, to apply the emulsion glue to the backbone as it passes through the emulsion glue pot 40. The bindery operator can manually and/or mechanically adjust the emulsion glue wheels up or down in the emulsion glue to control the amount of emulsion glue deposited on the emulsion glue wheels which is subsequently applied to the backbone. The amount of emulsion glue adhering to the glue wheels as they make contact with the backbone is also partly determined by the proximity of the emulsion glue wheel scrapers to the emulsion glue wheels. The scraper setting, or distance between the glue wheel scrapers and their corresponding glue wheels, can be measured via the emulsion glue scraper measuring device 82. If required, subsequent adjustment to the distance can be made by an emulsion glue scraper adjustment element to facilitate removal of varying amounts of emulsion glue deposited on the emulsion glue wheels. Adjustment of the scraper settings via the emulsion glue scraper adjustment element may be manual, mechanical, or electronic.

The layer thickness of the emulsion glue applied to the grinded book block 23 is further adjusted by the stripper wheel assembly 42 which removes excess emulsion glue from the backbone. The stripper wheel assembly 42 which includes a stripper wheel and a corresponding stripper wheel scraper (not shown), operates by rotating the stripper wheel contra to the direction of backbone travel. The stripper wheel, like the emulsion glue wheels, can be manually and/or mechanically adjusted to remove varying amounts of emulsion glue from the backbone as the backbone travels across the stripper wheel assembly 42. The stripper wheel scraper operates much like the emulsion glue wheel scrapers. A stripper wheel scraper setting, or distance between the stripper wheel scraper and the stripper wheel, can be measured via the stripper wheel scraper indicating device 84. If required, subsequent adjustment to the distance can be made by a stripper wheel scraper adjustment element to facilitate removal of varying amounts of emulsion glue deposited on the stripper wheel. Thus, a stripper wheel scraper setting causing the stripper wheel scraper to be further from the surface of the rotating stripper wheel removes less emulsion glue than a setting causing the scraper to be closer to the stripper wheel. The emulsion glue removed from the backbone by the stripper wheel assembly 42 is drained and discarded.

To ensure optimum dryness of the emulsion glue, the backbone of grinded book block 23 is then subjected to the set of gas burners 44, for example burners 54, 56, 58, 60, as it is carried in a conveyor fashion to the side bead glue pot 48. The temperature of the set of gas burners 44 may be monitored and adjusted by the controller 80 via the thermocouples coupled to the gas burners 54, 56, 58, 60. Instead or in addition, the temperature of the gas burners 54, 56, 58, 60, may be adjusted by the bindery operator. After passing over the burners 44, the backbone of the grinded book block 23 is subjected to the ambient air blast generator 46 where additional drying takes place.

Application of the hot melt to the lower sides of the grinded book block 23 occurs at the side bead glue pot 48 to ensure that the endsheets of the grinded book block 23 adhere to the cover. The temperature of the hot melt in the side bead glue pot 48 is monitored via the first thermocouple 70. Similarly, application of the hot melt to the backbone of grinded book block 23 occurs at the backbone glue pot 50 in preparation for book cover application. The grinded book block 23 may be referred to as book 25 upon the addition of the hot melt glue to the backbone of grinded book block 23. The temperature of the hot melt in the backbone glue pot 50 is monitored via the second thermocouple 72. Adjustments to the temperature of the hot melt in both the side bead glue pot 48 and the backbone glue pot 50 may be made manually by the bindery operator or electronically. In addition, temperature adjustments may be made via the controller 80. For soft cover books, a book cover is applied to the book 25 after the final hot melt glue application at the backbone glue pot 50. For hardcover books, however, the book 25 is passed over the chill roll 52 where the hot melt glue is cooled, or set, to a temperature rendering the book 25 suitable to receive the book cover as discussed in connection with FIG. 1.

Before now, there has been no recognition that controlling bindery process variables such as the temperatures of the glue pots, the temperatures of burners, ambient temperature and humidity of the air surrounding the binder subassembly 14, moisture content of the backbone, etc., can reduce the incidence of book signature and/or book cover delamination during the book bindery process. It has been found, however, that the binding adhesion between the book cover and the book are correlated to appropriate control of certain bindery process variables. Similarly, the binding adhesion of the individual book pages within the book are correlated to appropriate control of certain bindery process variables.

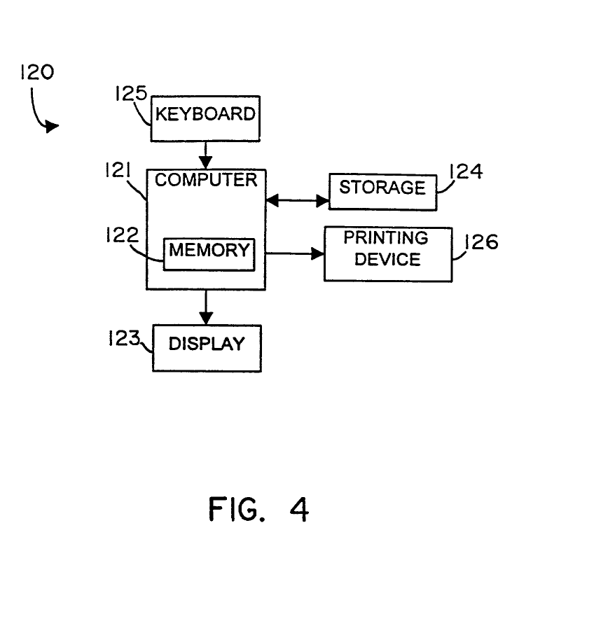

A cause and effect relationship between certain bindery process variables and adhesive defects may be established through utilization of a decision-tree induction method. The decision-tree induction method is one variation of a data mining technique, described below in connection with FIGS. 4, 5A, 5B, 6, 7A, and 7B. Typically, application of data mining to a system, such as book binding system 10, requires four steps. First certain bindery process variables, or attributes of the bindery process, are identified. Next, data is collected using sensors coupled to the bindery process variables during operation of the book binding system 10. The data is correlated to the quality of the books produced by the book binding system 10. Based on the results of the correlation, optimum values or ranges are selected for operation of the bindery process variables to prevent the occurrence of bindery problems in the book binding system 10. A controller, such as controller 80, or other feedback mechanisms can be used to ensure that, during subsequent book binding runs, the bindery process variables are kept within their “determined” optimum values or ranges in order to prevent bindery problems such as book cover and signature delamination.

Table 1 is a partial listing of 10 bindery process variables used to determine a cause and effect relationship between certain bindery process variables and adhesive defects in the book binding system 10.

TABLE 1

| Location | Sensor Type | Purpose |
|---|---|---|
| gas burner 54 | thermocouple | temperature of burner |
| gas burner 56 | thermocouple | temperature of burner |
| gas burner 58 | thermocouple | temperature of burner |
| gas burner 60 | thermocouple | temperature of burner |
| side bead glue pot 48 | thermocouple | temperature of hot melt |
| backbone glue pot 50 | thermocouple | temperature of hot melt |
| moisture sensor 66 | IR moisture | moisture content of backbone |
| | sensor | prior to hot melt application |
| viscometer 68 | viscometer | viscosity of emulsion glue |
| ambient humidity | humidity sensor | humidity above binder |
| sensor 62 | | subassembly line |
| ambient temperature | temperature | temperature above binder |
| sensor 64 | sensor | subassembly line |

As illustrated in Table 1, sensors strategically placed in locations throughout the glue assembly station 24 of the binder subassembly line 14 may be used to collect data from book binding runs occurring during, for example, a three month period. Data, for example burner temperature data, may be collected for each of a number of bindery process variables as individual signatures 18 are transformed into finished books 29 during each book binding run. Although data collection may be accomplished via the controller 80, other data collections methods may be also be used. After each binding book run, the integrity of the binding adhesive strength of selected finished books is determined in laboratory quality testing. The results from the book quality tests are then aligned with, and compared to the data collected from the bindery process variables.

In an actual analysis, in a system in which data was collected for 59 process variables, application of the data mining technique revealed that optimum adhesion of the book cover and the signatures to the backbone occurred when the temperature measured in side bead glue pot 48 and the backbone glue pot 50 was maintained within a range between 365 to 373 degrees Fahrenheit, and when the temperatures of the set of gas burners 44 was maintained between 1280 to 1320 degrees Fahrenheit. In addition, application of data mining techniques revealed that optimal adhesion was achieved when the ambient temperature and humidity surrounding binder subassembly line 14 were maintained at below 97 degrees Fahrenheit and below 57 percent, respectively. Furthermore, it was found that the various paper types and book thicknesses may interact differently with different viscosity levels of the emulsion glue, and that an appropriate combination of paper types and book thicknesses and viscosity of the emulsion glue may be ascertained by using a moisture sensor detect the moisture of the emulsion glue after it has been applied to the backbone. Data collected from the moisture sensor 66, located in the glue assembly station 24 between the burners 44 and the glue pots 48 and 50, was thus used to correlate optimum emulsion glue viscosity and scraper setting values to book cover delamination in books having various paper types and thicknesses. The moisture sensor 66 may be any moisture sensor, for example a BSP-901 Infrared System moisture sensor manufactured by Moisture Register Products, Inc., that is capable of providing measurement values of the moisture content of the emulsion glue after its application to the backbone. Overall, it was found that optimal adhesion for the various paper types and book thicknesses may be achieved when the gas burner temperatures are keep between 1280 and 1320 degrees Fahrenheit, and the glue pot temperatures are kept between 365 and 373 degrees Fahrenheit.

Based on the results of data mining or other correlation techniques, book cover and signature delamination may be reduced in the book binding system of FIG. 1 by optimally setting and/or controlling the bindery process variables so that they remain at one or more values or ranges that have been determined as values or ranges at which book cover and signature delamination is less likely to occur within the book binding system 10. Optimally setting and/or controlling the bindery process variables may be accomplished by the controller 80 which is programable to monitor values and ranges, and to transmit multiple output signals capable of adjusting values and ranges for the bindery process variables. Although the controller 80 in binder subassembly 14 may be programmed to monitor and control variables such as the temperatures of the glue pots, the temperatures of burners, ambient temperature and humidity of the air surrounding the binder subassembly 14, viscosity and scraper settings associated with the emulsion glue, and the moisture content of the emulsion glue after application of the emulsion glue to the backbone, other bindery process variables may also be used or controlled.

Generally, to reduce book cover and signature delamination by monitoring and controlling the temperatures of the set of gas burners 44, the controller 80 is connected to a series of sensors, for example a series of thermocouples, each thermocouple in communication with, and corresponding to, each of the gas burners 54, 56, 58, 60, to receive indications of the temperature of each of those burners. If the thermocouples indicate to the controller 80 that the burner temperatures are not at the determined value or within the determined range, the controller 80 generates an alarm or other output signal indicating this fact. The output signal may, for example, alert a user via any alarm, such as a bell, a whistle, a display device (such as a CRT, a flashing light, etc.) or any other display to indicate that the gas burners 54, 56, 58, 60 should be adjusted to force the burner temperatures back to the determined value or back within the determined range. Adjustments to the gas burners 54, 56, 58, 60, may be accomplished automatically via a control signal sent from the controller 80 to a burner adjustment mechanism, for example a heating element(s) within the gas burners 54, 56, 58, 60. Similarly, the controller 80 may be connected to a thermocouple in communication with, and corresponding to, the side bead glue pot 48 to receive indications of the temperature of the hot melt in each of the side bead glue pot 48. Likewise, the controller 80 may be connected to a thermocouple in communication with, and corresponding to, the backbone glue pot 50 to receive indications of the temperature of the hot melt in each of the backbone glue pot 50. If the thermocouples indicate to the controller 80 that the hot melt temperatures are not at the determined values or within the determined ranges, the controller 80 generates an alarm or other output signal indicating this fact. The output signal may, for example, alert a user via any alarm, such as a bell, a whistle, a display device (such as a CRT, a flashing light, etc.) or any other display to indicate that the glue pot 48, 50, should be adjusted to force the glue temperatures back to the determined value or back within the determined range. Adjustments to the glue pots 48, 50, may be accomplished automatically via a control signal sent from the controller 80 to glue pot adjustment mechanisms, for example, heating elements within the glue pots 48, 50. In this manner, the controller 80 operates to reduce the occurrence of future book cover and signature delamination based on one or more temperatures.

In a particular embodiment, it has been discovered advantageous to keep the gas burners 54, 56, 58, 60 between approximately 1280 and 1320 degrees Fahrenheit, and to keep the side bead glue pot 48, the backbone glue pot 50 between approximately 365 and 373 degrees Fahrenheit. Of course, these ranges may change depending upon the type of hot melt being used, and the type of book binding system being controlled as well as other factors specific to the individual book binding system/paper type combination used.

Furthermore, different types of paper types as well as different book thicknesses have been shown to interact with different levels of emulsion glue viscosity to yield an array of inconsistent adhesive strengths. Likewise, different types of paper types as well as different book thicknesses have also been shown to interact with different scraper settings to yield an array of inconsistent adhesive strengths. Moisture content measurements of the emulsion glue after application to the backbone but directly before application of the hot melt, were found to be a useful indicator for making a determination of optimum values for the viscosity of the emulsion glue and the emulsion glue scrapper settings for the various paper types and book thicknesses.

Generally, to reduce book cover and signature delamination based on the viscosity of the emulsion glue, the controller 80, coupled to the viscometer 68. The viscometer 68 acts as a sensor by measuring the viscosity of the emulsion glue. The viscometer 68, however, may also be programmed to directly adjust the viscosity of the emulsion glue based on the measurement. Thus, if the viscometer 68 indicates that the viscosity of the emulsion glue is not at the determined value or within the determined range, adjustments to the viscosity of the emulsion glue may be made by the controller 80 or a controller in the viscometer 68. The viscometer 68 may be any viscometer, for example a model VTE250 Process Viscosel, manufactured by Brookfield Engineering Laboratories. Inc., that provides continuous viscosity monitoring and/control and is responsive to controller 80.

Generally, to reduce book cover and signature delamination by monitoring and controlling the scraper settings of the glue wheel scrapers and the stripper wheel scraper, the controller 80 is communicatively coupled to the scraper setting measuring devices 82, 84, to receive indications of the scraper settings. If the scraper setting measuring devices 82, 84, indicate to the controller 80 that any of the distances between the stripper wheel scraper and the stripper wheel, and the emulsion glue wheel scrapers and the emulsion glue wheels, are not within the determined values or determined ranges, the controller 80 generates a control signal. Upon receiving the control signal, the emulsion glue scraper adjustment element of the emulsion glue scraper adjusts the emulsion glue scraper setting. Likewise, the stripper wheel scraper adjustment element of the stripper wheel scraper adjusts the stripper wheel scraper setting. In addition, the controller 80 may generate an output signal to alert a user via any alarm to indicate that the scraper settings should be adjusted. In this manner, the controller 80 automatically operates to reduce the occurrence of future book cover and signature delamination based on the viscosity of the emulsion glue, the moisture content of the emulsion glue, and the scraper settings of the stripper and glue wheels.

In a particular embodiment, it has been discovered advantageous to generate a set of moisture content ranges as measured by the moisture sensor 66, correlated to specific scraper settings and viscosity ranges, which may be used to form a table of acceptable operational ranges for the scraper settings and emulsion glue viscosity for different paper types and book thicknesses while the gas burner temperature is keep between, for example, 1280 and 1320 degrees Fahrenheit, and the glue pot temperatures are kept between, for example, 365 and 373 degrees Fahrenheit. Of course, these ranges may change depending upon the type of book binding system being controlled as well as other factors specific to the individual book binding system/paper type combination used.

Thus, as will be understood, the particular gas burner temperatures, glue pot temperatures, emulsion glue temperature and moisture content, and scraper settings leading to reduced book cover and signature delamination within the book binding system 10 may differ for different book binding systems and may, in fact, differ for different conditions within any individual book binding system. As a result, it may be advisable to identify the particular determined temperatures, moisture content, etc. values or ranges that are appropriate for reducing book cover and signature delamination in each different book binding system. While such values or ranges may be determined by, for example, trial and error methods or any other desired method, an appropriate temperature, moisture content, etc. value and/or range is preferably determined from data indicating relevant temperature, moisture content, etc. for prior runs of the book binding system 10 in which both book cover and signature delamination occurred and did not occur.

To perform this analysis, a database, which may be located in the controller 80 or elsewhere, stores data indicating gas burner temperatures, hot melt glue pot temperatures, emulsion glue viscosity and moisture content, ambient air temperatures and humidity, emulsion glue scraper settings, and other attributes for a plurality of book binding runs along with an indication of whether a delamination occurred or did not occur within each of the plurality of book binding runs. Typically, a book binding run in this context is defined by the book binding associated with a minimum of 385 books for a binomial test with a statistic confidence level of 0.95 and an error size of 0.05. Thereafter, any desired method of identifying proper temperatures, viscosity values, or moisture content, etc. values or ranges that result in reduced delamination based on the stored data may be used. Such methods may include the use of any correlation analysis, for example, a neural network, an expert system, etc. However, one method of identifying one or more proper temperatures, viscosity values, or moisture content values or ranges that result in reduced delamination uses a decision tree-induction correlation analysis and will be described below in connection with FIGS. 4, 5A, 5B, 6, 7A, and 7B.

If desired, the correlation analysis may be performed using various book binding attribute data, such as the burner temperatures, the glue pot temperatures, the emulsion glue viscosity and moisture content, the ambient temperature and humidity data, paper type data, etc. discussed above, to determine if a correlation between any combination of these attributes results in an increased or decreased occurrence of book cover and signature delamination. Of course, when a particular correlation between one or a combination of two or more attributes is identified, this correlation may be displayed via a printer, a monitor, or other display device and may be used to control the book binding system to avoid occurrence of delamination. Furthermore, when a correlation between the burner temperatures, the glue pot temperatures, the emulsion glue viscosity and moisture content, and the ambient temperature and humidity, etc. and delamination (or other problems) is identified, the temperature, viscosity, moisture content, etc. in the system may be modified to reduce delamination.

A preferred method and device for analyzing collected data pertaining to book binding attributes (particularly burner and hot melt glue pot temperatures, the viscosity of the emulsion glue, the scraper setting for the stripper wheel scraper and the glue wheel scrapers, and the moisture content of the backbone just prior to application of the hot melt step) to thereby identify correlations between one (or a combination of two or more) of these attributes and book cover and signature delamination is discussed hereinafter. Referring now to FIG. 4, a system 120 that constructs induction trees for the purpose of identifying conditions leading to a particular result (e.g., book cover and signature delamination) in a multi-variant system includes a computer 121 (which may be any type of processor) having a memory 122 therein. The computer 121, which may be integral with or a part of the controller 80 of FIG. 3, is connected to a display device 123 (such as a CRT) and to a data storage device 124 that stores data used by the computer 121. If desired, the storage device 124 may comprise a disk drive that alternatively or additionally allows a user to input data into the computer 121. An input device, such as a keyboard 125, allows a user to enter data and otherwise interact with the computer 121. A printing device 126 is attached to the computer 121 and is capable of printing induction trees developed by the computer 121 and/or other information, such as alarms, generated by the computer 121. Other input/output devices might alternatively or additionally be used.

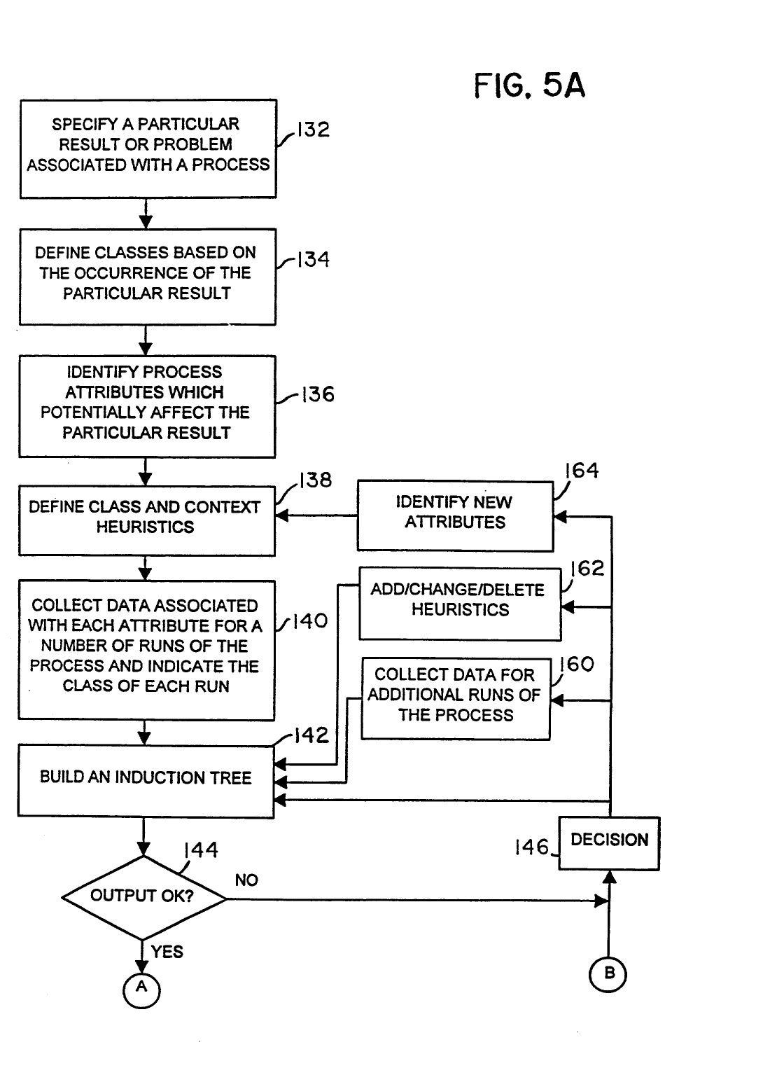

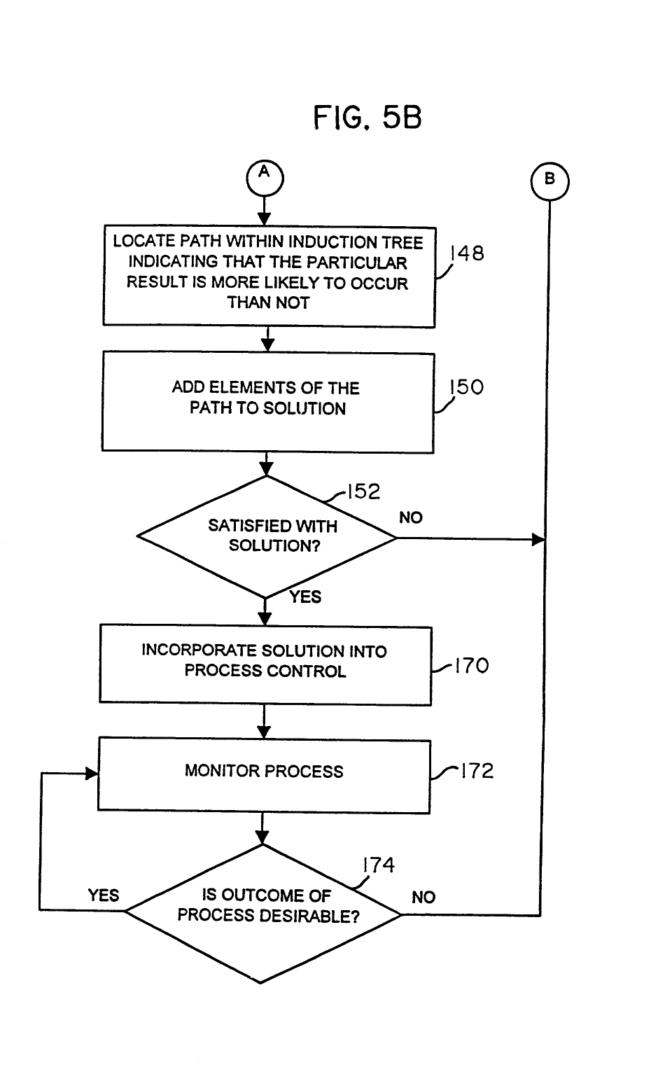

Referring now to FIGS. 5A and 5B, a flowchart illustrates a method that may be implemented in part by programming executed by the computer 121 (FIG. 4) that (1) identifies conditions leading to a particular result, such as book cover and signature delamination, in a book binding system/process, that (2) identifies particular burner and hot melt glue pot temperature ranges, emulsion glue viscosity values, scraper settings for the stripper wheel scraper and the glue wheel scrapers, and the moisture content of the backbone associated with the decreased occurrence of book cover and signature delamination in the book binding system, and/or that (3) prescribes and implements a solution that decreases the probability of occurrence of, for example, book cover and signature delamination in the book binding system. Although the particular result described hereinafter (e.g., a book cover and signature delamination) comprises an undesirable outcome of a process and the method is used to decrease the occurrence of the particular result, the particular result could instead comprise a desirable outcome or other desirable effect associated with the process (e.g., no book cover and signature delamination) and the method could be used to increase the probability that the particular result will occur.

At the start of the method (step 132), a domain expert who is knowledgeable about a process specifies a particular result (such as a book cover and signature delamination) associated with the system (e.g., a book binding system). At a step 134, the domain expert defines classes associated with the particular result. Typically, the nonoccurrence of the particular result is associated with a first class and the occurrence of the particular result is associated with a second class.

At a step 136, the domain expert identifies attributes or features of the process that are potentially relevant to the occurrence of the particular result of the process. These attributes can be continuous, e.g., real valued, or discrete. If an attribute is discrete, the domain expert must identify the discrete values or categories that a value of the attribute can assume. For the case of book cover and signature delamination, these attributes may include burner and hot melt glue pot temperatures, the viscosity of the emulsion glue, the scraper setting for the stripper wheel scraper and the glue wheel scrapers, and the moisture content of the backbone just prior to application of the hot melt step. Of course, other book binding attributes may be used as well including, for example, ambient book binding room conditions such as humidity, temperature, etc.

In order for the method to be ultimately successful in determining the cause of the particular result (such as a book cover and signature delamination) or in prescribing a solution that increases or decreases the probability of the occurrence of the particular result, it may be important that all of the attributes that are actually relevant to the particular result be identified. If attributes that are actually relevant to the particular result are not identified at the step 136, the method may fail to determine the cause of the particular result or may produce an incomplete or inaccurate solution. However, identifying attributes that are not actually relevant to the occurrence of the particular result will not degrade the performance of the method or the solution ultimately obtained thereby.

At a step 138, the domain expert may identify class and context heuristics or rules associated with the attributes identified at the step 136. A class heuristic represents a known relationship between the distribution of classes and specific portions of the range of an attribute. A class heuristic preferably specifies that a particular range of an attribute should include a higher or lower proportion of attribute values that are associated with a particular one of the classes than any other range of the attribute. Class heuristics are used to prevent the method from searching for induction rules that are already known to be inaccurate in connection with the domain or the process.

A context heuristic represents an order of priority between two or more attributes. A context heuristic may, for example, specify that it is meaningless to search for induction rules associated with one of the identified attributes before searching for induction rules associated with a different one of the attributes. Thus, it may not make sense to search for an induction rule associated with a binder subassembly line before searching for one associated with a book binding site. The attribute with the lower priority is said to be inactive within the context heuristics until the method has examined the attribute with the higher priority.

At a step 140, data or values are collected for each of the attributes for each of a number of runs of the process. This data may include values for burner and hot melt glue pot temperatures, values for the viscosity of the emulsion glue, values for the glue and stripper wheel scraper settings, and the moisture content of the backbone just prior to application of the hot melt step, as identified above. A plurality of data records are then created, each of which includes values for the attributes identified at the step 136 along with the class associated with a particular run of the process. The plurality of records are stored in a database that is used to develop induction rules associated with the process stored within, for example, the storage device 124 of FIG. 4, preferably in text format. It is important that the values for the attributes are measured accurately. Inaccurate and/or incomplete data may lead to an inaccurate determination of the cause of the particular result or may lead to an inaccurate solution for increasing or decreasing the probability of the occurrence of the particular result. As a result, data preprocessing that, for example, replaces outliers (clearly inaccurate data), fills in missing data, eliminates records having incorrect or missing data, etc. may be performed to purify the data.

At a step 142, the records created at the step 140 are used to construct an induction tree. Preferably, at the step 142, the domain expert is allowed to guide the construction of the induction tree interactively. Each induction tree created at the step 142 indicates relationships between values of the attributes and the classes identified for the process (e.g., whether a book cover delamination occurred or no book cover delamination occurred). An indication of the induction tree may be provided to a user via, for example, the printing device 126 or the display device 123 of FIG. 4.

At a step 144, the domain expert reviews the induction tree to determine whether the induction tree is satisfactory, i.e., whether any potentially relevant induction rules may be suggested thereby. If the induction tree is not satisfactory because, for example, no induction rules can be identified or the induction rules that are identified are not implementable in the process due to economic, social, quality or other reasons, the method proceeds to a decision step 146.

However, if the induction tree is satisfactory, the method proceeds to a step 148 of FIG. 5B at which the domain expert locates one or more paths within the induction tree that indicate that the particular result is more likely to occur than not. Conversely or in addition, the domain expert may also locate one or more paths within the induction tree that indicate that the particular result is less likely to occur than not. Each path identified by the expert may comprise one or more attribute values or ranges of attribute values associated with runs of the process that fall exclusively or almost exclusively into one of the classes defined at the step 134. Any particular induction tree may suggest any number of paths that lead to one or more components of a solution which, when used to control the process, will affect the probability of the occurrence of the particular result.

Rather than identifying induction rules manually by identifying such paths, the identification of induction rules can be performed automatically. A book written by J. R. Quinlan, C4.5: Programs for Machine Learning (1991), (in particular, chapters 5 and 9 and the appendix thereof), discloses a technique that automatically searches for and identifies induction rules within an induction tree. At a step 150, the components of the paths identified at the step 148 are added to a solution list, which may be stored in the memory 122 or the storage device 124 associated with the computer 121 of FIG. 4. Typically, different paths of either the same or different induction trees may identify different ranges of the same attribute as one of the solution components. If these ranges are not mutually exclusive, and where it is practical to do so, the domain expert preferably adopts the range included in all of the paths as the ultimate solution component.

At a step 152, the domain expert determines whether the solution as compiled in the solution list is satisfactory. If the domain expert believes that the solution is not complete, the method proceeds to the decision step 146 of FIG. 5A.

At the step 146, the domain expert chooses one of a number of options in order to improve the quality of the induction tree constructed at the step 142 and to enhance the solution compiled at the step 150. Following the step 146, a new induction tree may be built at the step 142 with further input from the domain expert.

Alternatively, at the step 146, the method may proceed to a step 160 at which data is collected for additional runs of the book binding system 10. The resulting additional records are added to the database used at the step 142 to build an induction tree. In this manner, a more complete or informative induction tree can be constructed at the step 142.

Also, at the step 146, the method may proceed to a step 162 wherein the domain expert changes, adds and/or deletes one or more of the class and/or context heuristics previously identified for the domain. This step is particularly useful when an induction tree indicates that the class heuristics previously identified are incorrect.

Alternatively, at the step 146, the method may proceed to a step 164 wherein the domain expert identifies additional attributes that may be relevant to the occurrence of the particular result but that were not previously identified. This step is particularly useful when the induction tree developed at the step 142 does not present any clear results. At the step 164, the domain expert can also delete attributes from the set of attributes previously identified when, for example, the expert believes that those attributes are not, in fact, relevant to the particular result. If at least one new attribute is identified at the step 164, the method returns to the step 138 at which class and context heuristics for the new or already identified attributes are defined. At the step 140, data for a new plurality of runs of the process are collected to produce records having data for all of the attributes, including the newly identified attribute(s).

When, at the step 152 of FIG. 5B, the expert is satisfied with the solution obtained at the step 150, the solution is incorporated into the process by running the process at a step 170 so that the process attributes have values within the ranges specified by the solution. For example, the gas burner and hot melt glue pot temperatures within the glue assembly station 24 of the binder subassembly line 14 of book binding system 10 FIG. 1 may be controlled to keep the the gas burner and hot melt glue pot temperatures at a particular value or within a range determined to be associated with a reduced occurrence of book cover and signature delamination. At a step 172, the process is monitored during subsequent runs thereof and a determination is made at a step 174 whether the solution has been adequate in achieving a desired outcome, that is, eliminating or reducing the particular result (e.g., book cover delmination) from the process in an acceptable manner.

If the outcome of the process is desirable, the method returns to the step 172 which continues to monitor the outcome of the process. If, however, the outcome of the process is not desirable or if the outcome of the process returns to an undesirable condition during further monitoring of the process, the method returns to the step 146 of FIG. 5A at which the expert builds a new induction tree, collects additional data for the identified attributes, changes heuristics or identifies new attributes, all in an effort to generate a more complete or accurate solution, that is, to identify better gas burner and hot melt glue pot temperatures values or ranges or to identify other correlations between the viscosity of the emulsion glue, the scraper settings for the stripper wheel scraper and the glue wheel scrapers, and the moisture content of the backbone just prior to application of the hot melt step and book cover delaminations or other binder subassembly line problems.

Generally, the induction tree constructed at the step 142 has a root and any number of nodes that branch from either the root or from another node of the induction tree. The induction tree is constructed iteratively and performs the same operations at the root and each node using only data contained in records that are in a “current” database that has a content that varies with the position in the induction tree. At the root of the induction tree, the current database includes all of the records produced at the steps 140 and 160. The current database associated with any particular node of the induction tree includes a subset of the records of the database associated with the node (or root) from which the particular node branches.

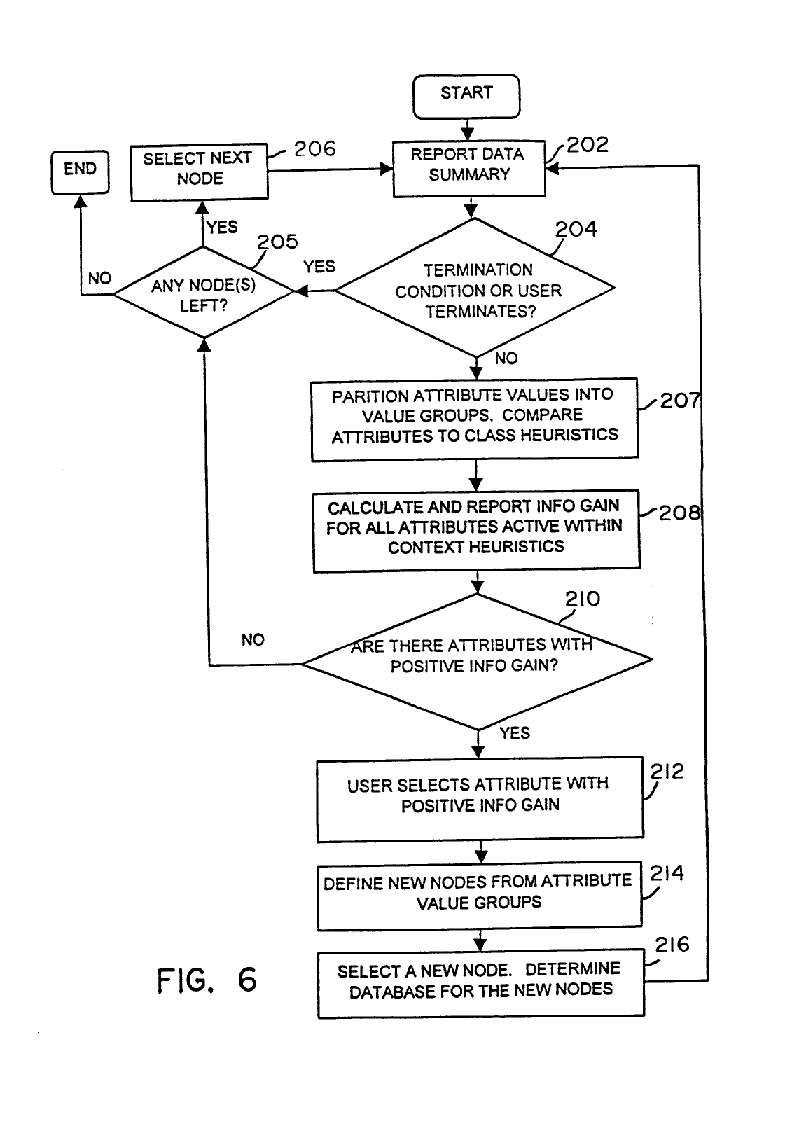

FIG. 6 illustrates a flowchart of programming, preferably in LISP (a commercially available programming language particularly suited for artificial intelligence applications), that is executed by the computer 121 to implement the step 142 of FIG. 5A. The programming begins at a block 202 which reports a summary of the records within the current database to the user via, for example, the display 123 of FIG. 4. Preferably, this summary indicates the number of records within the current database that are associated with each of the classes identified at the step 134 of FIG. 5A. The summary also identifies whether all of the records within the current database have the same value for any particular attribute and provides a characterization list that identifies the attributes for which that condition is satisfied. The summary may also list the values of one or more attributes and indicate the classes of the records having these values to provide the expert with more information about the records within the current database.

A block 204 then determines if a node termination condition is present. Preferably, a node termination condition exists if at least a predetermined percentage of the records within the current database are associated with the same class, in which case the node is labeled as an endpoint or a leaf of the induction tree. A node termination condition may also exist if all of the attributes active within the context heuristics have been selected as a branch within a path from the node to the root of the tree. Alternatively, a user can manually terminate the node using, for example, the keyboard 125 of FIG. 4 or another input device.

If a node termination condition exists, the block 204 terminates branching from the node and a block 205 determines if any unexamined nodes remain. If no unexamined nodes remain, the induction tree is complete and the program ends. If, however, all of the nodes have not been examined, a block 206 locates the next node, updates the current database to be that associated with the next node and returns control to the block 202. Alternatively, the block 206 can allow a user to select the next node to examine.

If the block 204 does not find a termination condition, a block 207 places each of the attributes in the characterization list into a context set identified for that node. The context set at each node is used to determine if an attribute is active within the context heuristics. The context set for a particular node (other than the root) includes: (1) the context set for the node from which the particular node branched (this node hereinafter referred to as the “previous node”); (2) any attribute identified in the characterization list by the block 202 for the particular node; and (3) the attribute chosen as the branch from the previous node to the particular node. The context set for the root of the induction tree contains only those attributes identified in the characterization list at the root of the induction tree.

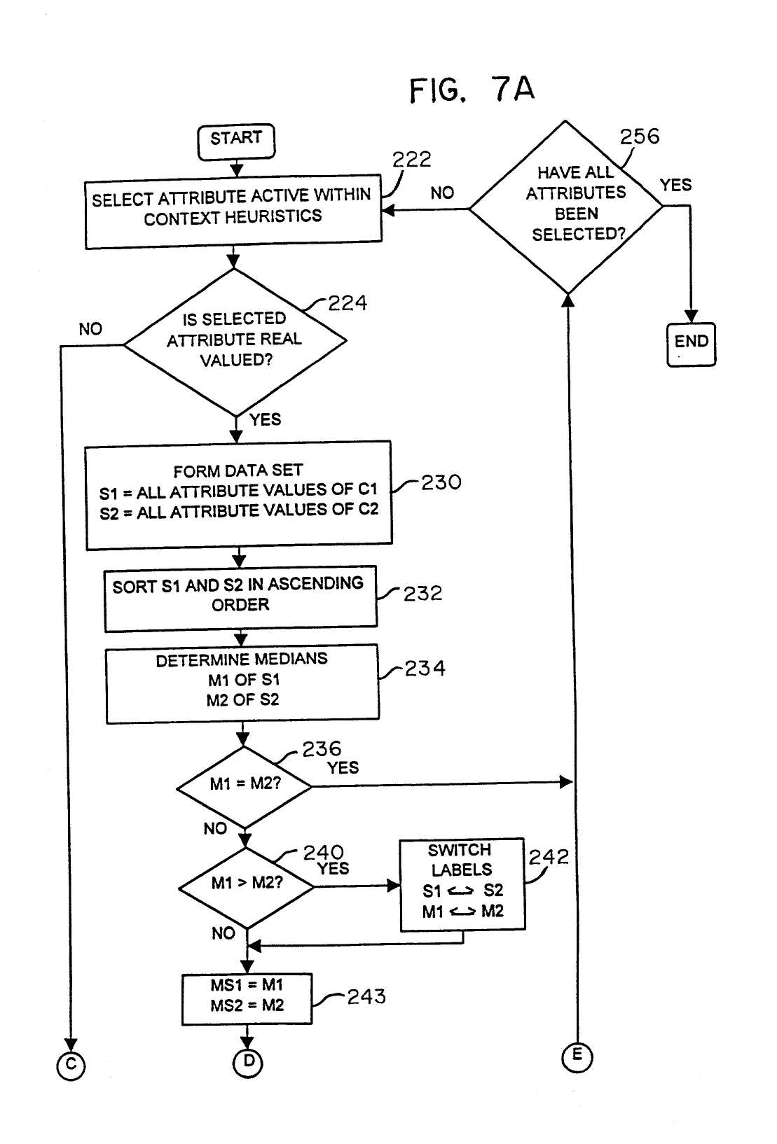

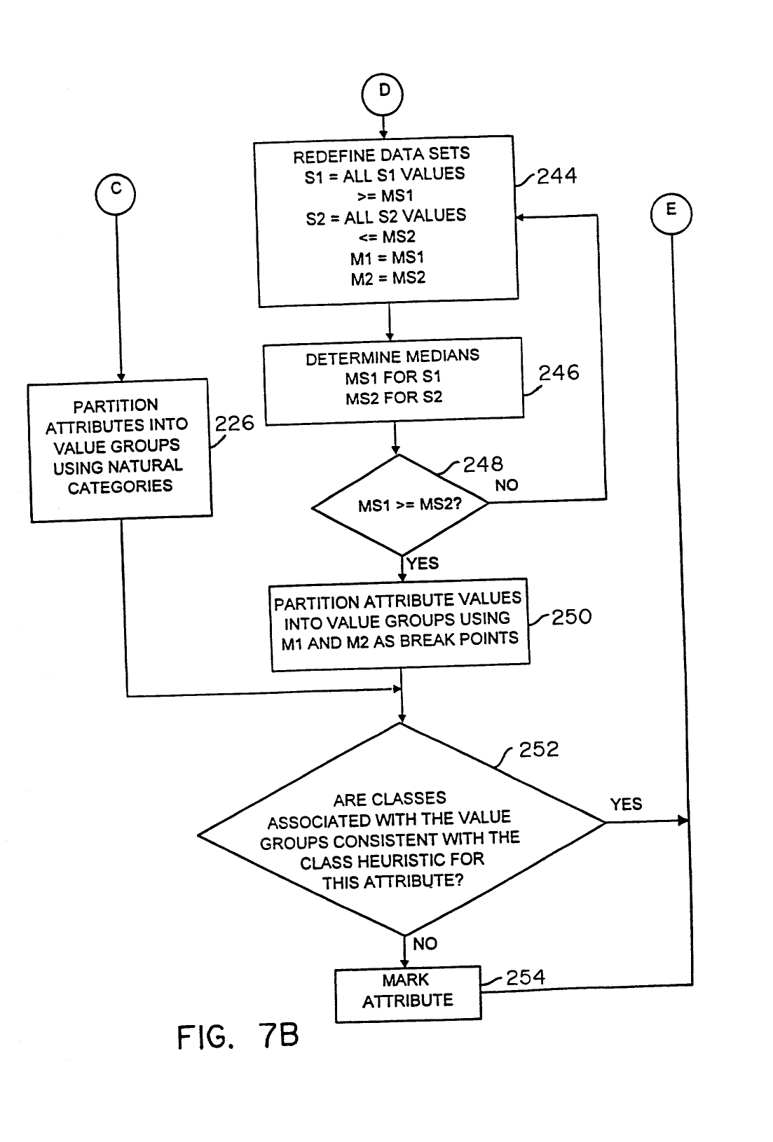

The block 207 then partitions each active attribute into a finite number of value groups. Discrete attributes are partitioned into value groups according to discrete categories associated therewith. Real valued or continuous attributes are partitioned into value groups based on the actual values of that attribute within the current database and the classes associated with those values, as described hereinafter with respect to FIGS. 7A and 7B. The block 207 may also determine whether the actual distribution of the classes among the value groups is consistent with the class heuristics defined for the attributes. If the block 207 discovers an inconsistency between the actual distribution of the classes among the value groups of an attribute and the distribution specified in the class heuristic, that attribute is marked with a disagreement flag.

Next, a block 208 calculates a figure of merit, such as the normalized information gain value for each of the attributes active within the context heuristics, using the value groups developed by the block 207. The information gain value of an attribute is a measure of the distribution of the classes across the value groups of the attribute. The information gain value is defined such that a value of “1” indicates a complete or “perfect” correlation between the attribute value groups and the classes. In such a case, each attribute value group contains instances of only one class or is an empty set and, hence, the value groups completely discriminate the classes. Information gain values between “0” and “1” indicate less than complete correlation between the value groups and the classes, i.e., there is some distribution of classes among the value groups of the attribute. Information gain values close to “1” indicate a high correlation between the attribute value groups and the classes and information gain values close to “0” indicate a low correlation between the attribute value groups and the classes. An information gain value of “0” indicates that no correlation between the attribute value groups and the classes exists and thus, that the classes are randomly distributed throughout the value groups of the attribute. In such a case, the distribution of the classes is not affected by the selection of the attribute and so, selection of the attribute at the node would not be particularly helpful.

Preferably, the information gain value IG(A) of an attribute A is calculated as follows:

IG(A)=I(p,n)−E(A)

wherein:

$$I ( p , n ) = - \frac{p}{p + n} {log}_{2} \frac{p}{p + n} - \frac{n}{p + n} {log}_{2} \frac{n}{p + n} \qquad ( 2 )$$

and

$$\begin{matrix}E ( A ) = Expected value of attribute A \\ = {\sum }_{i = 1}^{vg} \frac{{p}_{i} + {n}_{i}}{p + n} \cdot I ( {p}_{i} , {n}_{i} )\end{matrix} \qquad ( 3 )$$

where:

p=Number of records within the current database associated with the first class; and

n=Number of records within the current database associated with the second class;

and where:

vg=Total number of value groups associated with attribute A;

pᵢ=Number of records within the current database that are associated with the value group i of attribute A and that are associated with the first class;

nᵢ=Number of records within the current database that are associated with the value group i of attribute A and that are associated with the second class; and

I(pᵢ,nᵢ)=I(p,n) calculated for p=pᵢ and n=nᵢ;

Although the information gain value IG(A) is useful, it is biased toward those attributes that have a greater total number of value groups. Thus, an attribute having two value groups each with an equal probability of having a particular class associated therewith will have an information gain value that is less than the information gain value of an attribute having six value groups each with an equal probability of having a particular class associated therewith. To correct this bias, the following normalizing information gain value NG(A) for attribute A is calculated by the block 208:

$$\begin{matrix}NG ( A ) = \frac{IG ( A )}{NF ( A )} \\ \text{where:} & ( 4 ) \\ NF ( A ) = - {\sum }_{i = 1}^{vg} [ \frac{{p}_{i}}{{p}_{i} + {n}_{i}} {log}_{2} \frac{{p}_{i}}{{p}_{i} + {n}_{i}} + \frac{{n}_{i}}{{p}_{i} + {n}_{i}} {log}_{2} \frac{{n}_{i}}{{p}_{i} + {n}_{i}} ] & ( 5 )\end{matrix}$$

Next, a block 210 determines if any of the attributes active within the context heuristics have positive normalized information gain values. If none of the attributes has a positive normalized information gain value, the block 210 terminates further branching from the node and control passes to the blocks 205 and 206 which select the next node to be examined. If, however, one or more of the attributes have a positive normalized information gain value, a block 212 presents each of the attributes active within the context heuristics and the normalized information gain value associated therewith to the expert via the display 123 of FIG. 4.

Preferably, the attributes are ranked according to the normalized information gain values associated therewith. Such ranking may include the categories of: BEST, for the attribute having the highest normalized information gain value; HIGHLY USEFUL, for attributes having a normalized information gain value at least 95 percent of the highest normalized information gain value; USEFUL, for attributes having a normalized information gain value between 90 and 95 percent of the highest normalized information gain value; MARGINAL, for attributes having a normalized information gain value between 75 and 90 percent of the highest normalized information gain value; QUESTIONABLE, for attributes having a normalized information gain value between 50 and 75 percent of the highest normalized information gain value; LAST RESORT, for attributes having a normalized information gain value above zero but below 50 percent of the highest normalized information gain value; and USELESS, for attributes having a normalized information gain value of substantially zero. Any other desired categories can be alternatively or additionally used.

Preferably, any attribute that has been marked by the block 207 as having a distribution of classes among its value groups that is inconsistent with a class heuristic is identified as such by, for example, placing brackets around the displayed normalized information gain value of that attribute. Alternatively, the normalized information gain value of any such attribute can be set to zero.

The block 212 then permits selection of one of the attributes as a branch within the induction tree. Preferably, the block 212 allows the domain expert to interactively select one of the attributes that, also preferably, has a positive normalized information gain value. It is important to note, however, that the expert need not select the attribute having the highest normalized information gain value, but can select any of the attributes active within the context heuristics according to any desired criteria. Alternatively, the block 212 can automatically select one of the attributes and, in such a case, preferably selects the attribute with the highest normalized information gain value. However, automatic selection of an attribute may lead to a less complete or desirable solution.

A block 214 causes branching on the chosen attribute such that new nodes are created within the induction tree, each of which corresponds to a value group of the chosen attribute. A block 216 permits a user to interactively terminate or to select each of the new nodes for examination, defines a new current database for each selected node and places the selected attribute into the context set for that node. The new current database includes all of the records within the database of the previous node having values associated with the value group of the new node.

When one of the nodes has been selected, the block 216 stores an indication of the other nodes that were created by the block 214 and an indication of the databases and the context sets associated with those nodes for future examination in, for example, the data storage unit 124 of FIG. 4. The block 216 then returns to the block 202 which begins an iteration for the new node.

Referring now to FIGS. 7A and 7B, the operation of the block 207 of FIG. 6 will be described in detail. A block 222 selects a present attribute and determines whether the present attribute is active within the context heuristics. In doing so, the block 222 compares the context set for the node with a context list associated with the present attribute. The context list associated with the present attribute identifies those attributes that must be branched upon in the induction tree before the present attribute can become active. If all of the attributes within the context list associated with the present attribute are also within the context set of the node being examined, the present attribute is deemed to be active. If the present attribute has an empty context list it is always active within the context heuristics.

A block 224 then determines if the present attribute is real valued. If not, then the present attribute is a discrete valued attribute and a block 226 of FIG. 7B partitions the present attribute into value groups based on the categories associated with the present attribute that have been previously defined by the domain expert.

If the block 224 determines that the present attribute is real valued, a block 230 forms two data sets S1 and S2 from the values of the present attribute. The data set S1 includes all of the values of the present attribute in records within the current database associated the first class. The data set S2 includes all of the values of the present attribute in records within the current database associated with the second class.

A block 232 sorts all of the values within each of the data sets S1 and S2 in ascending order and a block 234 determines the medians M1 and M2 for the data sets S1 and S2, respectively. A block 236 determines whether the medians M1 and M2 are equal and, if so, the present attribute cannot be partitioned. Control is then passed to a block 256 and, as a result, the present attribute will only have one value group and the normalized information gain value associated therewith will be zero.

If, on the other hand, the medians M1 and M2 are not equal to one another, a block 240 tests to determine if the median M1 is greater than the median M2. If so, a block 242 re-labels the data set S1 as data set S2 and the median M1 as median M2 and, simultaneously, re-labels the data set S2 as data set S1 and the median M2 as median M1. Furthermore, the block 242 stores a class flag that indicates that the data sets S1 and S2 have been re-labeled.

Next, a block 243 sets median values MS1 and MS2 equal to medians M1 and M2, respectively. A block 244 of FIG. 7B redefines the data set S1 to include only the values within the data set S1 that are greater than or equal to the median MS1. The block 244 also redefines the data set S2 to include only the values within the data set S2 which are less than or equal to the median MS2. Furthermore, the block 244 sets the medians M1 and M2 equal to the medians MS1 and MS2, respectively. A block 246 then determines the medians MS1 and MS2 of the new data sets S1 and S2, respectively. Next, a block 248 determines whether the median MS1 is greater than or equal to the median MS2 and, if not, control returns to the block 244 which redefines the data sets S1 and S2.

The blocks 244, 246 and 248 are re-executed until the block 248 determines that the median MS1 is greater than or equal to the median MS2. When this condition occurs, a block 250 partitions the selected real valued attribute into three value groups. The first value group includes all of those attribute values associated with records within the current database that are less than or equal to M1. The second value group includes all of those attribute values associated with records within the current database that are greater than M1 and less than M2. The third value group includes all of those attribute values associated with records within the current database that are greater than or equal to M2. If desired, additional value groups can be defined by ranges at the upper and/or lower ends of the attribute value continuum that are associated exclusively with one class.

Although the blocks 234 and 246 are described herein as determining the medians of the sets S1 and S2, any other desired statistical properties of the sets S1 and S2, including the means thereof, could instead be determined and used in the method illustrated in the flowchart of FIGS. 7A and 7B. It should be noted that the above-described method of partitioning real valued attributes is computationally simple and inexpensive and, therefore, can be applied at every node of the induction tree that is labeled as a branching point. If desired, a real-valued attribute may be checked to see if it has a windowed characteristic wherein one of the classes associated with the attribute is windowed by the other class. This procedure is described in the patent application Ser. No. 09/026,267 filed on Feb. 19, 1998, by Evans and is assigned to the assignee of the present invention, the disclosure of which is hereby expressly incorporated by reference herein.

A block 252 determines whether the distribution of the classes among the value groups developed by the blocks 226 and 250 is consistent with any class heuristics previously identified at the steps 138 or 162 of FIG. 5A. For real valued attributes, it is assumed that the first class is associated with the data set S1, meaning that proportionately more of the values within the data set S1 are associated with the first class than are associated with the second class. Likewise it is assumed that the second class is associated with the data set S2 such that proportionately more of the values within the data set S2 are associated with the second class than are associated with the first class. If, however, the class flag indicates that the data sets S1 and S2 have been relabeled during the discretization process, it is assumed that the first class is associated with the data set S2 and that the second class is associated with the data set S1.

With respect to real valued attributes, the block 252 determines if the class associated with the data set S1 or S2, as defined by the class flag, is consistent with the class heuristic. If so, the distribution of classes is said to be consistent with the class heuristic wherein the latter indicates whether higher or lower values of an attribute are expected to be associated with one of the classes. A class associated with the data set S1 is consistent with a class heuristic that indicates that lower values of the attribute are more likely to be associated with the class than higher values. Likewise a class associated with the data set S2 is consistent with a class heuristic that indicates that higher values of the attribute are more likely to be associated with the class than lower values of the attribute.

Preferably, for discrete valued attributes, a class heuristic indicates a value or a value group of the attribute and the class that should be predominantly associated with that value group. Thus, for discrete valued attributes, the block 252 determines whether there is a higher or lower percentage of a class within the value group defined by the class heuristic than the percentage of that class in any other range of the attribute. For example, if the class heuristic identifies that one value group is more likely to be associated with the first class, the block 252 compares the percentage of values in the one value group that are associated with the first class to the percentage of the values of that attribute associated with the first class in each of the other value groups. If the percentage of values associated with the first class is highest in the one value group, the distribution of classes among the value groups is consistent with the class heuristic.

If the block 252 determines that the distribution of classes predominantly associated with the value groups of the attribute is inconsistent with the class heuristic identified for the attribute, a block 254 marks the attribute with a disagreement flag.

After the attribute has been marked by the block 254 or, if the block 252 does not detect an inconsistency between the distribution of the classes of the values within the value groups of the attribute and a class heuristic defined for the attribute, the block 256 of FIG. 7A determines if all of the attributes that are active within the context heuristics have been selected. If so, the method proceeds to the block 208 of FIG. 6. Otherwise, the block 222 selects the next attribute for partitioning.

The above-described decision-tree induction method (data mining) described in connection with FIGS. 4, 5A, 5B, 6, 7A, and 7B was used in order to establish a cause and effect relationship between certain bindery process variables and adhesive defects, for example book cover and signature delamination, of the books produced during the book binding process described in connection with FIGS. 1 and 3.

If desired, however, other types of analyses could be performed to determine correlations between one or more book binding attributes and the occurrence of delamination or other problems in a book binding system. Other such analyses include, but are not limited to, standard correlation analyses, neural networks, fuzzy logic systems, or any expert system analysis that stores and uses data pertaining to one or more such attributes for book binding runs in which the problem occurred and for book binding runs in which the problem did not occur. The commercial software product known as KnowledgeSEEKER (manufactured by Angoss Software International Limited) is one such expert analysis system.

Numerous modifications and alternative embodiments of the invention will be apparent to those skilled in the art in view of the foregoing description. Accordingly, this description is to be construed as illustrative only and not as limiting to the scope of the invention. The details of the structure may be varied substantially without departing from the spirit of the invention, and the exclusive use of all modifications, which are within the scope of the appended claims, is reserved.

It is claimed:

1. A device for determining conditions under which delamination of a book cover from a book in a book binding system is more likely to occur, the book binding system including a binder subassembly line having a multiplicity of glue assembly station elements, the device comprising:
a database that stores data related to a plurality of attributes corresponding to the multiplicity of glue assembly station elements for each of a number of book binding runs of the book binding system, wherein a book cover delamination occurred in some of the number of book binding runs and did not occur in others of the number of book binding runs; and
a processor that is adapted to be used to determine if there is a correlation between the stored data and the occurrence of book cover delamination in the book binding system.

2. The device of claim 1, wherein the processor implements a decision-tree induction algorithm to create an induction tree using the data.

3. The device of claim 1, further including an output device that displays the correlation between the data and the occurrence of book cover delamination when the correlation is determined.

4. The device of claim 1, wherein the processor determines at least a first and a second value for one of a plurality of attributes of one of the multiplicity of glue assembly station elements, wherein book cover delamination is less likely to occur at the first value than the second value.

5. The device of claim 1, wherein one of the glue assembly station elements is a set of one or more gas burners, and wherein the processor further determines a temperature value associated with the one or more gas burners where book cover delamination is less likely to occur.

6. The device of claim 5, wherein the temperature value comprises a temperature range between about 1280 degrees Fahrenheit and about 1320 degrees Fahrenheit.

7. The device of claim 1, wherein one of the glue assembly station elements is a sidebead glue pot having a hot melt glue therein, and wherein the processor further determines a hot melt glue temperature value associated with the hot melt glue where book cover delamination is less likely to occur.

8. The device of claim 7, wherein the hot melt glue temperature value comprises a temperature range between about 363 degrees Fahrenheit and about 373 degrees Fahrenheit.

9. The device of claim 1, wherein one of the glue assembly station elements is a backbone glue pot having a hot melt glue therein, and wherein the processor further determines a hot melt glue temperature range associated with the hot melt glue where book cover delamination is less likely to occur.

10. The device of claim 9, wherein the hot melt glue temperature value comprises a temperature range between about 363 degrees Fahrenheit and about 373 degrees Fahrenheit.

11. The device of claim 1, wherein one of the glue assembly station elements is an emulsion glue pot having an emulsion glue therein, and wherein the processor further determines a viscosity value associated with the emulsion glue where book cover delamination is less likely to occur.

12. The device of claim 1, wherein one of the glue assembly station elements is an emulsion glue pot having an emulsion glue therein and having one or more adjustable emulsion glue wheels with corresponding emulsion glue wheel scrapers, each emulsion glue wheel scraper having an emulsion glue wheel scraper setting, and wherein the processor further determines an emulsion glue wheel scraper setting value where book cover delamination is less likely to occur.

13. The device of claim 12, wherein the emulsion glue wheel scraper setting value comprises a range of values.

14. The device of claim 1, wherein one of the glue assembly station elements is a stripper wheel assembly having a stripper wheel with a corresponding stripper wheel scraper, the stripper wheel scraper having a stripper wheel scraper setting, and wherein the processor further determines a stripper wheel scraper setting value where book cover delamination is less likely to occur.

15. The device of claim 14, wherein the stripper wheel scraper setting value comprises a range of values.

16. The device of claim 1, wherein the processor further determines a moisture content value of an applied emulsion glue where the occurrence of book cover delamination is less likely to occur, the moisture content value of the applied emulsion glue determined after application of the emulsion glue to a backbone of a book.

17. The device of claim 16, wherein the processor further determines a correlation between the moisture content value and a viscosity of the emulsion glue where the occurrence of book cover delamination is less likely to occur.

18. The device of claim 16, wherein the processor further determines a correlation between the moisture content value and an emulsion glue wheel scraper setting value where the occurrence of book cover delamination is less likely to occur.

19. The device of claim 16, wherein the processor further determines a correlation between the moisture content value and a stripper wheel scraper setting value where the occurrence of book cover delamination is less likely to occur.

20. A book binding control system for use in a book binding assembly line having a plurality of glue assembly station elements, the book binding control system comprising:
(a) a sensor coupled to one of the plurality of glue assembly station elements, the sensor configured to measure a process value associated with the one of the plurality of glue assembly station elements to produce a sensor measurement;
(b) a controlled device configured to alter a parameter of the book binding assembly line; and
(c) a controller communicatively connected to the sensor to receive the sensor measurement, the controller configured to produce an output signal related to the controlled device based on the sensor measurement.

21. The book binding control system of claim 20, wherein the output signal is an alarm.

22. The book binding control system of claim 20, wherein the one of the plurality of glue assembly station elements is a sidebead glue pot, and wherein the sensor is a thermocouple coupled to the sidebead glue pot, the thermocouple providing a temperature measurement of a hot melt glue in the sidebead glue pot, and wherein the controlled device is a glue pot adjustment mechanism associated with the sidebead glue pot.

23. The book binding control system of claim 22, wherein the controlled device is communicatively coupled to the controller to receive the output signal, and wherein the output signal causes the glue pot adjustment mechanism to adjust the temperature of the hot melt glue in the sidebead glue pot to a temperature stored within the controller.

24. The book binding control system of claim 23, wherein the temperature stored within the controller comprises a temperature between about 363 degrees Fahrenheit and about 373 degrees Fahrenheit.

25. The book binding control system of claim 20, wherein the one of the plurality of glue assembly station elements is a backbone glue pot, and wherein the sensor is a thermocouple coupled to the backbone glue pot, the thermocouple providing a temperature measurement of a hot melt glue in the backbone glue pot, and wherein the controlled device is a glue pot adjustment mechanism associated with the backbone glue pot.

26. The book binding system of claim 25, wherein the controlled device is communicatively coupled to the controller to receive the output signal, and wherein the output signal causes the glue pot adjustment mechanism to adjust the temperature of the hot melt glue in the backbone glue pot to a temperature stored within the controller.

27. The book binding control system of claim 26, wherein the temperature stored within the controller comprises a temperature between about 363 degrees Fahrenheit and about 373 degrees Fahrenheit.

28. The book binding control system of claim 20, wherein the one of the plurality of glue assembly station elements is a set of one or more gas burners, and wherein the sensor is a thermocouple coupled to the set of one or more gas burners, the thermocouple providing a temperature measurement of the set of one or more gas burners, and wherein the controlled device is a burner adjustment mechanism associated with the set of one or more gas burners.

29. The book binding system of claim 28, wherein the controlled device is communicatively coupled to the controller to receive the output signal, and wherein the output signal causes the burner adjustment mechanism to adjust the temperature of the set of one or more gas burners to a temperature stored within the controller.

30. The book binding control system of claim 29, wherein the temperature stored within the controller comprises a temperature between about 1280 degrees Fahrenheit and about 1320 degrees Fahrenheit.

31. The book binding system of claim 20, wherein the controlled device is a humidifier or dehumidifier, and wherein the controlled device is communicatively coupled to the controller to receive the output signal, and wherein the output signal causes the humidifier or dehumidifier to adjust an ambient humidity of an area surrounding the binder assembly line to a humidity value stored within the controller.

32. The book binding system of claim 31, wherein the humidity value stored within the controller comprises a humidity equal to or below about 57 percent.

33. The book binding system of claim 20, wherein the controlled device is a heater or an air conditioner, and wherein the controlled device is communicatively coupled to the controller to receive the output signal, and wherein the output signal causes the heater or air conditioner to adjust an ambient temperature of an area surrounding the binder assembly line to a temperature value stored within the controller.

34. The book binding system of claim 33, wherein the temperature value stored within the controller comprises a temperature equal to or below about 97 degrees Fahrenheit.

35. The book binding system of claim 20, wherein the one of the plurality of glue assembly station elements is an emulsion glue pot assembly, and wherein the sensor is a viscometer coupled to the emulsion glue pot assembly, the viscometer providing a viscosity measurement of an emulsion glue in the emulsion glue pot assembly, and wherein the controlled device is a viscometer adjusting element associated with the viscometer.

36. The book binding system of claim 35, wherein the controlled device is communicatively coupled to the controller to receive the output signal, and wherein the output signal causes the viscometer adjusting element to adjust the viscosity of the emulsion glue in the emulsion glue pot assembly to a viscosity value stored within the controller.

37. The book binding system of claim 20, wherein the one of the plurality of glue assembly station elements is an emulsion glue pot assembly, and wherein the sensor is an emulsion glue wheel scraper indicating device coupled to an emulsion glue wheel scraper, the emulsion glue wheel scraper indicating device providing an indication of a distance between the emulsion glue wheel scraper and a corresponding emulsion glue wheel, and wherein the controlled device is an emulsion glue wheel scraper adjustment element associated with the emulsion glue wheel scraper.

38. The book binding system of claim 37, wherein the controlled device is communicatively coupled to the controller to receive the output signal, and wherein the output signal causes the emulsion glue scraper adjustment element to adjust the distance between the emulsion glue wheel scraper and the corresponding emulsion glue wheel to a distance value stored within the controller.

39. The book binding system of claim 20, wherein the one of the plurality of glue assembly station elements is a stripper wheel assembly, and wherein the sensor is a stripper wheel scraper indicating device coupled to a stripper wheel scraper, the stripper wheel scraper indicating device providing an indication of a distance between the stripper wheel scraper and the stripper wheel, and wherein the controlled device is a stripper wheel scraper adjustment element associated with the stripper wheel scraper.

40. The book binding system of claim 39, wherein the controlled device is communicatively coupled to the controller to receive the output signal, and wherein the output signal causes the stripper wheel scraper adjustment element to adjust the distance between the stripper wheel scraper and the stripper wheel to a distance value stored within the controller.

41. The book binding system of claim 20, wherein the sensor is a moisture sensor coupled to the book binding system, the moisture sensor configured to measure a moisture content value of a backbone of the book prior to an application of a hot melt glue, and wherein the controlled device is a viscometer adjusting element associated with a viscometer, wherein the viscometer is communicatively coupled to an emulsion glue pot assembly having an emulsion glue therein, and wherein the viscometer adjusting element is configured to provide an adjustment to a viscosity of the emulsion glue.

42. The book binding system of claim 41, wherein the controlled device is communicatively coupled to the controller to receive the output signal, the output signal causing the viscometer adjusting element to adjust the viscosity of the emulsion glue to a viscosity value stored within the controller.

43. The book binding system of claim 20, wherein the sensor is a moisture sensor coupled to the book binding system, the moisture sensor configured to measure a moisture content value of an emulsion glue after application of the emulsion glue to a backbone of the book, and wherein the controlled device is an emulsion glue wheel scraper adjustment element associated with an emulsion glue wheel scraper of an emulsion glue pot assembly, the emulsion glue wheel scraper corresponding to an emulsion glue wheel, the emulsion glue wheel scraper adjustment element configured to provide an adjustment to a distance between the emulsion glue wheel scraper and the emulsion glue wheel.

44. The book binding system of claim 43, wherein the controlled device is communicatively coupled to the controller to receive the output signal, and wherein the output signal causes the emulsion glue wheel scraper adjustment element to adjust the distance between the emulsion glue wheel scraper and the emulsion glue wheel to distance value stored within the controller.

45. The book binding system of claim 20, wherein the sensor is a moisture sensor coupled to the book binding system, the moisture sensor configured to measure a moisture content value of an emulsion glue after application of the emulsion glue to a backbone of the book, and wherein the controlled device is an stripper wheel scraper adjustment element associated with a stripper wheel scraper of stripper wheel assembly, the stripper wheel scraper corresponding to a stripper wheel, the stripper wheel scraper adjustment element configured to provide an adjustment to a distance between the stripper wheel scraper and the stripper wheel.

46. The book binding system of claim 45, wherein the controlled device is communicatively coupled to the controller to receive the output signal, and wherein the output signal causes the stripper wheel scraper adjustment element to adjust the distance between the stripper wheel scraper and the stripper wheel to distance value stored within the controller.

47. The book binding system of claim 20, wherein the sensor is a moisture sensor coupled to the book binding system, the moisture sensor configured to measure a moisture content value of an emulsion glue after application of the emulsion glue to a backbone of the book, and wherein the controlled device is a burner adjustment mechanism associated with one or more gas burners, and wherein the burner adjustment mechanism is configured to provide an adjustment to a temperature of the one or more gas burners.

48. The book binding system of claim 47, wherein the controlled device is communicatively coupled to the controller to receive the output signal, the output signal causing the burner adjustment mechanism to adjust the temperature of the one or more gas burners to a temperature value stored within the controller.

49. A binder subassembly line comprising:
(a) an emulsion glue pot assembly configured to apply an emulsion glue layer to a book block backbone;
(b) a gas burner assembly configured to partially dry the emulsion glue on the book block backbone;
(c) an ambient air blast generator assembly configured to further dry the emulsion glue on the book block backbone;
(d) a glue pot assembly configured to apply a hot melt glue to the book block backbone;
(e) a viscometer coupled to the emulsion glue pot assembly, wherein the viscometer is configured to measure a viscosity of the emulsion glue; and
(f) a comparison device configured to compare the measured viscosity to a viscosity value stored within the comparison device.

50. The binder subassembly line of claim 49, wherein the comparison device is further configured to produce an output signal based on the comparison of the measured viscosity to the viscosity value.

51. The binder subassembly line of claim 50, wherein the output signal is an alarm.

52. The binder subassembly line of claim 50, wherein the output signal is a control signal adapted to cause an adjustment to the viscosity of the emulsion glue.

53. A binder subassembly line comprising:
(a) an emulsion glue pot assembly configured to apply an emulsion glue layer to a book block backbone;
(b) a gas burner assembly configured to partially dry the emulsion glue on the book block backbone;
(c) an ambient air blast generator assembly configured to further dry the emulsion glue on the book block backbone;
(d) a glue pot assembly configured to apply a hot melt glue to the book block backbone;
(e) a glue wheel scraper indicating device coupled to a glue wheel scraper in communication with a corresponding glue wheel rotatable in the emulsion glue pot assembly, wherein the glue wheel scraper indicating device is configured to measure a distance between the glue wheel scraper and the glue wheel; and
(f) a comparison device configured to compare the measured distance to a distance value stored within the comparison device.

54. The binder subassembly line of claim 53, wherein the comparison device is further configured to produce an output signal based on the comparison of the measured distance to the distance value.

55. The binder subassembly line of claim 54, wherein the output signal is an alarm.

56. The binder subassembly line of claim 54, wherein the output signal is a control signal adapted to cause an adjustment to the distance between the glue wheel scraper and the glue wheel.

57. A binder subassembly line comprising:
(a) an emulsion glue pot assembly configured to apply an emulsion glue layer to a book block backbone;
(b) a gas burner assembly configured to partially dry the emulsion glue on the book block backbone;
(c) an ambient air blast generator assembly configured to further dry the emulsion glue on the book block backbone;
(d) a glue pot assembly configured to apply a hot melt glue to the book block backbone;
(e) a stripper wheel scraper indicating device coupled to a stripper wheel scraper in communication with a stripper wheel rotatable in the emulsion glue pot assembly, wherein the stripper wheel scraper indicating device is configured to measure a distance between the stripper wheel scraper and the stripper wheel; and
(f) a comparison device configured to compare the measured distance to a distance value stored within the comparison device.

58. The binder subassembly line of claim 57, wherein the comparison device is further configured to produce an output signal based on the comparison of the measured distance to the distance value.

59. The binder subassembly line of claim 58, wherein the output signal is an alarm.

60. The binder subassembly line of claim 58, wherein the output signal is a control signal adapted to cause an adjustment to the distance between the stripper wheel scraper and the stripper wheel.

61. A binder subassembly line comprising:
(a) an emulsion glue pot assembly configured to apply an emulsion glue layer to a book block backbone;
(b) a gas burner assembly configured to partially dry the emulsion glue on the book block backbone;
(c) an ambient air blast generator assembly configured to further dry the emulsion glue on the book block backbone;
(d) a glue pot assembly configured to apply a hot melt glue to the book block backbone; and
(e) a thermocouple assembly coupled to the gas burner assembly, wherein the thermocouple assembly is configured to measure a temperature at the gas burner assembly.

62. The binder subassembly line of claim 61 further comprising a comparison device configured to compare the measured temperature to a temperature value stored within the comparison device.

63. The binder subassembly line of claim 62, wherein the comparison device is further configured to produce an output signal based on the comparison of the measured temperature to the temperature value.

64. The binder subassembly line of claim 63, wherein the output signal is an alarm.

65. The binder subassembly line of claim 63, wherein the output signal is a control signal adapted to cause an adjustment to the temperature at the gas burner assembly.

66. A binder subassembly line comprising:
(a) an emulsion glue pot assembly configured to apply an emulsion glue layer to a book block backbone;
(b) a gas burner assembly configured to partially dry the emulsion glue on the book block backbone;
(c) an ambient air blast generator assembly configured to further dry the emulsion glue on the book block backbone;
(d) a glue pot assembly configured to apply a hot melt glue to the book block backbone;
(e) a thermocouple assembly coupled to the glue pot assembly, wherein the thermocouple assembly is configured to measure a temperature of the glue pot assembly; and
(f) a comparison device configured to compare the measured temperature to a temperature value stored within the comparison device.

67. The binder subassembly line of claim 66, wherein the comparison device is further configured to produce an output signal based on the comparison of the measured temperature to the temperature value.

68. The binder subassembly line of claim 67, wherein the output signal is an alarm.

69. The binder subassembly line of claim 67, wherein the output signal is a control signal adapted to cause an adjustment to the temperature of the glue pot assembly.

70. A binder subassembly line comprising:
(a) an emulsion glue pot assembly configured to apply an emulsion glue layer to a book block backbone;
(b) a gas burner assembly configured to partially dry the emulsion glue on the book block backbone;
(c) an ambient air blast generator assembly configured to further dry the emulsion glue on the book block backbone;
(d) a glue pot assembly configured to apply a hot melt glue to the book block backbone;
(e) an ambient humidity sensor, wherein the ambient humidity sensor is configured to measure an ambient humidity surrounding the binder subassembly line; and
(f) a comparison device configured to compare the measured ambient humidity to an ambient humidity value stored within the comparison device.

71. The binder subassembly line of claim 70, wherein the comparison device is further configured to produce an output signal based on the comparison of the measured ambient humidity to the ambient humidity value.

72. The binder subassembly line of claim 71, wherein the output signal is an alarm.

73. The binder subassembly line of claim 71, wherein the output signal is a control signal adapted to cause an adjustment to the ambient humidity surrounding the binder subassembly line.

74. A binder subassembly line comprising:
(a) an emulsion glue pot assembly configured to apply an emulsion glue layer to a book block backbone;
(b) a gas burner assembly configured to partially dry the emulsion glue on the book block backbone;
(c) an ambient air blast generator assembly configured to further dry the emulsion glue on the book block backbone;
(d) a glue pot assembly configured to apply a hot melt glue to the book block backbone;
(e) an ambient temperature sensor, wherein the ambient temperature sensor is configured to measure an ambient temperature surrounding the binder subassembly line; and
(f) a comparison device configured to compare the measured ambient temperature to an ambient temperature value stored within the comparison device.

75. The binder subassembly line of claim 74, wherein the comparison device is further configured to produce an output signal based on the comparison of the measured ambient temperature to the ambient temperature value.

76. The binder subassembly line of claim 75, wherein the output signal is an alarm.

77. The binder subassembly line of claim 75, wherein the output signal is a control signal adapted to cause an adjustment to the ambient temperature surrounding the binder subassembly line.

78. A binder subassembly line comprising:
(a) an emulsion glue pot assembly configured to apply an emulsion glue layer to a book block backbone;
(b) a gas burner assembly configured to partially dry the emulsion glue on the book block backbone;
(c) an ambient air blast generator assembly configured to further dry the emulsion glue on the book block backbone;
(d) a glue pot assembly configured to apply a hot melt glue to the book block backbone; and
(e) a moisture sensor coupled to the binder subassembly line, wherein the moisture sensor is configured to measure a moisture content value of the emulsion glue after application of the emulsion glue to the book block backbone.

79. The binder assembly line of claim 78 further comprising a control device, wherein the control device is adapted to compare the measured moisture content value to a preset moisture content value, and wherein the control device is adapted produce an output signal based on the comparison.

80. The binder subassembly line of claim 79, wherein the output signal is an alarm.

81. The binder subassembly line of claim 79, wherein the output signal is a control signal adapted to cause an adjustment to a viscosity of the emulsion glue.

82. The binder subassembly line of claim 79, wherein the output signal is a control signal adapted to cause an adjustment to a scraper setting of an emulsion glue wheel scraper.

83. A binder subassembly line comprising:
(a) a glue pot assembly configured to apply a hot melt glue to the backbone of the grinded book block;
(b) a thermocouple assembly coupled to the glue pot assembly, wherein the thermocouple assembly is configured to measure a temperature of the glue pot assembly; and
(c) a comparison device configured to compare the measured temperature to a temperature value stored within the comparison device.

84. The binder subassembly line of claim 82, wherein the comparison device is further configured to produce an output signal based on the comparison of the measured temperature to the temperature value.

85. The binder subassembly line of claim 83, wherein the output signal is an alarm.

86. The binder subassembly line of claim 83, wherein the output signal is a control signal adapted to cause an adjustment to the temperature of the glue pot assembly.
